(19) United States
(12) Patent Application Publication
(10) Pub. No.: US 2022/0253562 A1
(43) Pub. Date: Aug. 11, 2022

(54) INTELLIGENT SYSTEM FOR AUTHENTICATION OF HANDMADE CARPET

(71) Applicant: Amirhossein Roshanzamir, Dubai (AE)

(72) Inventor: Amirhossein Roshanzamir, Dubai (AE)

(21) Appl. No.: 17/624,590

(22) PCT Filed: Aug. 7, 2019
(86) PCT No.: PCT/IB2019/056711

§ 371 Date: Jan. 31, 2022

(51) Int. Cl. G06F 21/64; G06F 21/30; H04L 9/00; G06K 19/06

(52) U.S. Cl. CPC G06F 21/64; G06K 19/06037; H04L 9/50; G06F 21/30

(57) ABSTRACT

The invention “Intelligent system for authentication of handmade carpet”, is a system which integrates digital technologies including the Internet of Things (IoT) image processing, steganography, blockchain, asymmetric encryption and mobile technology to issue an irrevocable and immutable digital certificate for a handmade carpet and store it on the blockchain. This invention is intended to generate the fingerprint for a handmade carpet and share unique features, and journeys of this product among potential customers with data-backed evidence in a method that is accessible, trustworthy, and secure. The aim is to verify the provenance and crackdown and report counterfeit(s). This invention is very appealing for new carpets and creates substantial values for carpets which are about to be woven.

### TECHNICAL FIELD OF INVENTION

The present invention is related to the field of handmade carpet and, in particular, is focused on verifying the authenticity and proving the origin (provenance) of handmade carpet with Quick Response Code (QR Code) and embedded smart chip. It is also related to the Internet of Things (IoT) to fetch the location data of carpet weaving. It is also related to steganography to embed a secret message within the carpet pattern. It is also related to image processing to compare and contrast the map of woven carpet with the original map to identify random errors and record them as the carpet fingerprint. It is also related to blockchain to store all features of carpet in an irrevocable and immutable digital certificate. It is also related to asymmetric encryption to secure data, and finally, it is related to a mobile app to access data.

### PRIOR ART

The concept “intelligent carpet” was first brought forward in 2010, which its aim was to help elderly people with disabilities. In this project, a warning system active by sensors in the carpet when an elderly person falls and it can call the nurse to help. Then pattern discovery and movement disorders were considered in 2012 that can improve by a physiotherapist and also it was characterized that the intelligent carpet is operational in identifying burglars and environmental threat factors, the way that they a warning system active by sensors in the carpet.

The invention with U.S. Pat. No. 8,186,231B2 patent No. in 2008 22 Sep., by David Graumann & Mark Yarvis named Method & Apparatus for Scanning a Textile, filed in the USA patent office provide a new method for rapid interaction of sensitive point in carpet, which reminds receiving and transferring sensory lines when an object meets the carpet that can identify the object by monitoring it. In this method, one or more transmission circuit serves to identify one or more unique signal or sensory lines which are devised in the carpet to identify an object in the carpet.

In other invention, with U.S. Pat. No. 7,671,981B1 patent No. in 2007 27 Jun., by Walid A. Atia, et all named System for Spectroscopic Carpet Identification, filed in the USA patent office is a tunable laser spectroscopic carpet identification system which includes a tunable laser spectroscopic system to generate tunable signals that transfer to a sample carpet. The system finds the tunable signal after interacting with sample carpet, through which an analyzer can correlate the spectral response of a carpet sample to the chemical composition of a carpet sample. In an example, the spectroscopic system consists of a laser cavity in which the signal is generated, a semiconductor enhancement medium in the laser cavity and a tuning element to control the adjustable signal wavelength in the laser cavity is created. To deal with changes in water content, the analyzer estimates the water content of the carpet sample using the spectral response of the carpet sample and then determines the chemical composition of the carpet specimen to some extent based on the estimated water content.

In other invention, with U.S. Pat. No. 8,208,494B2 patent No. in 2014 10 Jun., by Steven Thaddeus Cibor named Code Based Product Tracking Methods & Apparatus, filed in the USA patent office Provides a method and apparatus for tracking carpet production including: Creating, through a server, in a product database configured to store carpet information (product information including carpet production information and carpet inspection information)

In other invention, with EP1261858A2 patent No. in 2001 6 Feb., by Rolf Bergter named Method for Identifying The Pile of Textile Materials, especially for Identifying PA6 & PA6 In Carpets, filed in the European patent office offers a method for identifying textile products such as carpet, especially for identifying polyamide 6 and polyamide 6.6 in carpet material. Clearly, the rug (textile) briefly disappears before being measured by high-pressure clean water or water absorbed by compressed air, may freeze, and spectroscopic measurements are performed immediately after that.

In other invention, with US20070296597A1 publication No. in 2006 27 Jun., by Luca Nizzola named RFID Tag System for a Carpet, filed in the USA patent office presents The tag of RFID system for the carpet, with one side of the carpet laying on the ground and the other side facing the front and the RFID tag on both sides.

In other invention, with US20130255325A1 publication No. in 2013 15 Mar., by Stuart Jenkins named Wool Pile Fabric Including Security Fibers & Method of Manufacturing same, filed in the USA patent office is a method of producing products including: providing a knitting and a spinning feeder machine from knitting machines with wool fiber bolts and at least one security fiber which cover the fabrics and fibers at the same time.

In other invention, with U.S. Pat. No. 6,847,299B2 patent No. in 2002 1 Nov., by Theresa S. Franks named Identification Tag for Fine Art Registry System, filed in the USA patent office Provides tags for artwork (including paintings), artifacts, and other valuable items for unique identification in a registration and database system where each identity identifier includes a secret identification code and a second identification code. It is readable. The identification code in a magnetic media can only be read by a single reader device.

In other invention, with U.S. Pat. No. 6,563,510B1 patent No. in 2000 30 Mar., by Mary R. Rice named Paint Color Matching & Coordinating System, registered in the USA patent office is to present a method of display and identification of colored examples of supplement to painting that include following steps: receiving an input reference color: choose the reference color from a database of colors in a colored area that is close to visual color, and according to any portion of colored area as a whole area in one cluster of area. The colored portions overlap the area of all colors in the visual color area.

In other invention, with U.S. Pat. No. 6,885,286B2 patent No. in 2002 30 Aug., by Theresa S. Franks named Fine Art Registry System, Database & Method, registered in the USA patent office provide Fine Art Registry System, which in this method of database, they use the identification tags to artwork that each tag includes hidden identification code. Each tag is authorized for only one user that registered in the system and subsequently identification information for art user and the author is saved in database.

In other invention, with U.S. Pat. No. 7,561,735B2 patent No. in 2003 5 Dec., by Susan Levin named System & Process for Identifying, Choosing, & Matching Colors, registered in the USA patent office is a method of matching color and concordant reference to use by producers and consumers of artworks including allocating a unique identification code for each of several colors. This identification code includes color's type sign, color's value sign, selector color marker. The art work's producers correlate identification code for each color using the tag system or any other things and help consumers in matching and concording colors.

In other invention, with CN106037423A patent No. named Intelligent carpet with communication interface registered in china The intelligent carpet is provided with the communication interface which is arranged on the lateral side of the intelligent carpet and connected to a data recognition channel, and the data recognition channel is controlled by a judgment module and configured with unique identification information corresponding to the intelligent carpet in which the judgment module is positioned. A control order includes recognition information and control information matched with different intelligent carpets to control elements in different intelligent carpets. When the recognition information in the control order is matched with the unique identification information on the intelligent carpet, the recognition channel sends the control information into an order analysis module for analysis. The forwarding module outputs the control order to the adjacent intelligent carpet through the communication interface of the intelligent carpet.

Another invention with U.S. Pat. No. 6,208,771B1 patent No. registered in USA named Methods and apparatus for robust decoding of glyph address carpets. A captured image includes a portion of a set of two-dimensional address codes. The portion of address codes can be decoded to determine a discrete pointer uniquely defining the portion. The captured image is first processed to determine the orientation of the portion, and then decoded based on the orientation to determine the discrete pointer. To determine the orientation of the portion, the portion is first analyzed to determine values at discrete locations within the portion. The values at each location form a matrix of binary data. The values of the matrix are then correlated to determine an orientation of the captured portion of two dimensional address codes. After determining the orientation of the portion, the values can be further analyzed to determine a discrete pointer that identifies the location of the portion within the address space defined by the two-dimensional address codes.

Another invention with U.S. Pat. No. 5,235,516A patent No. named Electronic creel mapping registered in USA is A method for identifying each yarn in a fabric. Bar-coded tracer tapes in yarn packages are placed on a creel; similarly the creel position associated with the package is read and transmitted to a PC memory. The computer calculates the age of each package and the difference between the oldest and youngest packages and signals the operator whenever any package exceeds a predetermined difference. Nonuniformities in the carpet may then be traced back to creel position, yarn package and conditions under which the yarn was made.

### DESCRIPTION OF THE INVENTION

The present invention is an Intelligent System which integrates digital technologies including IoT, image processing, steganography, the blockchain, asymmetric encryption and mobile technology to generate the fingerprint for a handmade carpet, issue an irrevocable and immutable digital certificate and then store it on the blockchain. This invention is intended to share unique provenance, features, and journeys of a handmade carpet among potential customers with data-backed evidence in a method that is accessible, trustworthy, and secure. The aim is to verify the provenance and crackdown and report counterfeit(s). Counterfeiting carpets are replicas of the real carpets, often produced with the intent to take advantage of the superior value of the original one. The system uses a combination of digital technologies, including hardware structures, software, and specific algorithms to record and verify a credible provenance.

The system starts to work by identifying and collecting the data-backed evidence and features of handmade carpet in complimentary stages and storing them on the blockchain. At the first stage, the map of the handmade carpet is designed in black and white, based on the main lines of the map, which is there as pre-existing knowledge and methodology. By scanning this original map, it is stored in a digital format for identification as the first data-backed block in the system. Other key features such as the designer(s), and location of the design as well as the default pattern that can be found from known patterns of carpet design or emerging patterns, along with this original map, are maintained in this first data block of the carpet. After that, the carpet map with colored punctuation from a black and white design turns into a color map. By completing the colored map, we can scan the detailed colored map and include the name of the carpet dye worker, dye house location as another data block in the system.

The third block will hold the following data: The threading frame of the handmade carpet is made and referred to as “warp yarns”, along with the yarn count, the yarn's material, the direction of the yarn, the density of the number of warps in each ridge, the person performing the threading of the warps steps as well as the date and location of threading of the warps. In this stage, a picture of carpet threading of the warps is also added as a piece of evidence for further validation.

In the next step, the carpet's margin is woven into which the material of the weft is used for the margin of the carpet, the density of the threads, the date of margin weaving, the weaver(s), and location of weaving the margin, are all integrated and stored in the fourth block. The photographed image of this stage is also maintained as a history of the carpet in the same associated block. Based on a handmade carpet map, a certain number of initial ridges (rows) of the carpet can be woven in this step. Based on how the handmade carpet, in which, after weaving each ridge with the passage of the ridge from the weft, i.e. by combing the carpet, compression is completed, we can fix the precise position of each ridge.

Also, a smart chip is embedded inside the carpet from the time weaving starts with low energy wireless IP network via the Internet of Things (IoT) or Bluetooth to integrate with Global Positioning System (GPS). This requires a simple mobile app that periodically (monthly intervals) pings out to the GPS to fetch the current location of the carpet weaving and communicate it through the smartphone of the weaver(s) with the system. This is the first and important inventive step which empowers the system to store periodic location data on the blockchain till weaving process completes. Later the origin of the carpet can be verified with this inventive step.

Steganography, which is the art and science of using digital images for secret communication, is also employed in the next step. Here the goal is to embed a message (such as the designer's name and time and date of design during the weaving process) in the pattern of carpet which only the sender (designer) and intended recipient (potential customers) can reveal it. Carpet's map offers an excellent platform to embed messages because of two major reasons. First, the pattern can be altered to a certain extent without losing their beauty and quality. Second, humans are unable to distinguish minor changes in image color and carpet pattern once the original map is woven. Therefore, we can turn for example 1000th to 1020th pixel or node in the pattern to a color that corresponds with a letter of the alphabet or a number. The rest of secret message can be stored in 1200th to 1220th pixel or node in the same manner. While the carpet appearance would not appear exceedingly distorted or perhaps slightly corrupted at worst, we can take decrypt colors and find the message. Therefore, this technique produces a unique feature like a fingerprint and helps to spot a counterfeit which does not carry the embedded message within the carpet.

After the steganography stage, the final accurate scan is taken from the completed woven carpet (i.e., it's surface and back). Considering the accuracy and precision of the scanner, we can generate a very high-precision image that each of the carpet piles creates a final image in the form of a color dot of tens of pixels. To minimize the error rate, the software in the system reduces the noise by examining each color dot that can form n*n pixels. If one of the color dots does not capture the minimal number of pixelated matrices, the system automatically corrects the data related to that color dot. In this stage, by scanning the design from the back of the handmade carpet, the knots are captured in colored dots, and a clear-cut, high-resolution image from the back of the handmade carpet is recorded in digital format. The matching of the scanned image on the surface of the handmade carpet with the scanned image on the back of the carpet is the third obvious invention step in the system and minimizes the carpet scan error.

After the third stage, we now have the original map and woven pattern recorded in the system and we use image processing to identify human errors and store them as the unique feature of a handmade carpet. This is the fourth inventive step in the system to verify the authenticity of any woven carpet. It is often said that all carpets are perfectly imperfect. Slight inconsistencies and imperfections prove that a carpet was woven by hand. That is because it is very likely that the weaver(s) make unintentional mistakes in weaving wrong colors due to human errors. Other errors such as knot loss, and carpet rugging (changing the width of the carpet due to the aggregation of the pulling force of the carpet weft) are all exclusive and distinct features of any handmade carpet. We can assume that if a carpet has a million knots, the possibility to have another carpet with the same map and with the same number of knots with the same error in a color pile in its x and y characteristics, is one to a million. That is why it can be argued that every carpet has exclusive and distinct features which cannot be replicated whatsoever, and that is how every carpet is perfectly imperfect. This is exactly like human fingerprints which are detailed and unique i.e. No two people not even identical twins have the same fingerprints. That is why we use fingerprint term for handmade carpet since there are no two woven handmade carpets having exactly similar errors. Therefore, the fourth inventive step of this system is to use image processing to compare the original carpet map with the scanned woven pattern to identify the imperfections and human errors during the weaving process. These errors are considered to be the fingerprint of a carpet and are stored on the blockchain as a part of the immutable digital certificate in the system.

In case of possible repairing, Information on carpet repairing, including the name of the person who repairs this carpet, correct possible defects and shrinking the surface of the carpet (i.e., surface scraping for uniformity), as well as completing the side margins, plus the time, date, size and count of the side yarn, the color of the side thread and the location information of the process are in the system. After a repairing operation, we need another scan of the whole carpet (back and surface scans) to record a fresh version of the woven carpet map in digital format for future reference.

Once the process of weaving is completed, all the features of carpet are integrated with a digital certificate and transformed into a QR Code to be stored on the blockchain. The QR code is physically attached at the back of the carpet. Also, blockchain provides ownership feature within the certificate, and once the carpet is sold to a new customer, the change of ownership is also recorded as a new immutable block. Transactions and features recorded on the blockchain about carpet are immutable, which means they cannot be deleted or changed. The reason is that each block has a timestamp and a link to a previous block. Therefore, any kind of modification or additional information about the carpet will be kept as a new block. Each transaction is stored in hundred thousands of nodes as a decentralized ledger and validated by former block, and the original record can be verified by the members of network.

Once the QR Code is scanned by mobile camera, the unique features and journeys of a handmade carpet with data-backed evidence are accessible in a trustworthy, and secure method. The access to the digital certificate of handmade carpet from the mobile app is managed by asymmetric cryptography, also known as public-key cryptography which uses public and private keys to encrypt and decrypt the digital certificate. The issuer's private key encrypts the electronic-ID or digital certificate of the handmade carpet, and then the third party or potential customer can decrypt it by issuer/sender's public key, but the customer can not change anything. The authenticity of the original certificate is verified by the same method. Once the private key of the issuer encrypts the certificate, it can be decrypted only with its public key. The private key is only available to the certificate issuer, and the public key is shared with a potential customer(s) who can only decrypt the certificate and verify its authenticity.

Even if one tries to copy the QR Code on the back of a carpet and mimic the original carpet's map thread by thread, pixel to pixel to replace the counterfeit with the original carpet, he would fail after this intelligent system is implemented. The reason simply is that there are endless of unique factors, including individual knots, densities, place of each knot, the color shade of the individual knots, length, width, and rugging of the carpet and the information of the owner and the location of the carpet as well as the fingerpirnt (random human errors and secret message) in weaving process which must be extracted and copied. Therefore, the chance of mistake and cost of reproduction is so high that makes this attempt almost impossible.

All the information associated with the original map of carpet, the woven pattern, and other important and unique features of a carpet are stored in an immutable electronic format to produce a digital certificate.

Therefore, the electronic certificate, which is the digital version of handmade carpet, is reinforced by the data-backed evidence stored on the blockchain, and this can be considered as the final and the fifth inventive step.

The certificate quickly emerges on a mobile app, once the QR code at the back of the carpet is scanned and then is verified by an asymmetric encryption method. From one side, the asymmetric cryptography embedded in the system makes it very difficult to access the features of the original carpet. On the other side, the QR code which contains data-backed evidence and the fingerprint of the carpet makes it impossible to duplicate the information and produce counterfeit(s).

The digital certificate enables us to share a transparent journey and data-backed evidence about carpet in a method that is accessible, trustworthy, and secure from the time weaving starts. The certificate also proves the ownership and provides below innovations:
Proves Origin by tag-chip and IoT which fetch the geographical location of weaving
Verifies Authenticity by carpet fingerprint recorded in an immutable certificate
Claims Ownership by blockchain
Reinforces Scarcity by image processing and the fingerprint
Creates Loyalty by mobile app
Increases Value by building trust and keep the history of carpet

This invention is very appealing for new carpets and creates substantial values for carpets which are about to be woven. However, some of the inventive steps can be implemented in used and old carpets to create value and bring benefits for carpet owners and sellers/buyers. It is very challenging and difficult to access Data-backed evidence of the provenance of used and old carpets. We formulate another innovative method and utilize the expertise of a professional expert in handmade carpet field to inspect and appraise so-called carpet and integrate whatever documents and evidence available by the owner in order to issue a digital certificate together with some multimedia from the existing status of carpet. The certificate is then transformed to QR code and later stored on the blockchain. The QR code is then attached at the back of carpet. Moreover, a smart chip can be embedded inside the carpet in order to fetch the location data of carpet wherever it is with Global Positioning System (GPS) while observing confidentiality and privacy issue. The owner of a carpet is the only one who has access to location data, but this data can be reviewed by the potential buyer during sales and transforming the ownership. Once the QR code at the back of the carpet is scanned, the certificate quickly emerges on a mobile app and then is verified in the blockchain by an asymmetric encryption method.

According to FIG. 1, The unique features of the handmade carpet together with data-backed evidence are collected and stored on the blockchain through a smart chip and weavers smartphone. Also multimedia including pictures, audio and video are recorded and stored on the blockchain.

According to FIG. 2, a smart chip periodically (monthly intervals) pings out to the GPS to fetch the current location of the carpet weaving and store it on the blockchain. Other multimedia data are also collected periodically and stored on the blockchain.

According to FIG. 3, steganography embeds a secret message such as the designer's name and time and date of design in the pattern of carpet during the weaving process.

Table 1) illustrates the coding of colors for further explanation.

According to FIG. 4, the weavers commit few mistakes on the color of pixel 4, 18, and 30. They are wrongly woven as Code D instead of Code A (pixel 4), Code C instead of Code B (pixel 18), Code D instead of Code C (pixel 30). These colors stored as the fingerprint of the handmade carpet on the blockchain. Also, colors in pixel 6, 13, and 15, are not properly scanned, and image processing algorithms enable us to correct the color according to the original color of the woven carpet

According to FIG. 5, the random errors of the replica carpet happen in pixel 6, 21, 26. We can see that they are wrongly woven as Code A instead of Code E (pixel 6), Code D instead of Code A (pixel 21), Code A instead of Code B instead (pixel 26). These are the fingerprint of replica carpet and are different from the original carpet in 6 pixels accordingly.

According to FIG. 6, the whole features of the handmade carpet is integrated into a digital certificate and transformed to QR code to be stored on the blockchain. According to FIG. 7, The certificate quickly emerges on mobile app once the QR code at the back of carpet is scanned and then is verified by an asymmetric encryption method.

According to FIG. 8, the QR code connects digital certificate with physical carpet. Even if the QR code is lost from the back of carpet, the fingerprint (random human errors and secret message) will maintain this connection.

### SUMMARY

The invention “Intelligent System of identifying, recording, and verifying the provenance of a handmade carpet by generating the fingerprint and issuing and storing a digital certificate on the block chain with data-backed evidence”, is a system which integrates digital technologies including the Internet of Things (IoT) image processing, steganography, blockchain, asymmetric encryption and mobile technology to issue an irrevocable and immutable digital certificate for a handmade carpet and store it on the blockchain. This invention is intended to generate the fingerprint for a handmade carpet and share unique features, and journeys of this product among potential customers with data-backed evidence in a method that is accessible, trustworthy, and secure. The aim is to verify the provenance and crackdown and report counterfeit(s). This invention is very appealing for new carpets and creates substantial values for carpets which are about to be woven. However, some of the inventive steps can be implemented in old and used carpets (woven many years ago) to create value and bring benefits for carpet owners and sellers/buyers.

### Description of a Practical Example

In an example of the present invention, we can assume a specific carpet map with a mosaic design of Mona-Lisa, a painting by Davinci, is designed as a black and white drawing. After completion, the design is stored in the system as the first block. Then, the map is completed by coloring and punctuation, and the scan of the completed map together with the map designer information is stored in the second block.

A smart chip is embedded inside the carpet as soon as weaving starts. The chip is integrated with Global Positioning System (GPS) via low energy wireless IP network to fetch the location of carpet weaving and record it periodically (monthly intervals) on the blockchain via weaver's smartphone.

After threading of the warps, the following data are all stored as a new block within the system:

The margin weaving, the primary ridges weaving, weaving part of the main map of the carpet, all the photographs, and images, along with the information of time, place, weaver and data of the quality of warp and weft threads, piles threads, and the data of the manufacturer of the threading warp (structure of the warps on the frame).

In the next step, steganography technique helps to embed a secret message such as the designer's name and time and date of design inside the pattern.

By completing the weaving process, a scan is taken from the surface side of the carpet and then another scan from the back. Therefore, we will have the digital image of the carpet map stored in the system. The image processing enables us to compare and contrast the image taken from the back and surface of the carpet and remove the noise. Now the system has the fine-tune image of woven carpet. In the next stage, image processing identifies the random human errors which happened during the weaving process. This is done by establishing a connection to one-to-one colored knots on the back of the carpet with piles on the surface and analyzing the discrepancy of the woven carpet with the original map in terms of the location of the colored knots as well as the dimensional change of the carpet in width and length. These errors which make any carpet perfectly imperfect are recorded in the system as a fingerprint. Also, in the case of repairing, all information including time and location are stored in the system.

Once the carpet is ready all the features of carpet are integrated into a digital certificate and transformed into a QR Code and then stored on the blockchain. The QR code is attached at the back of carpet. Also, blockchain provides ownership feature within the certificate, and once the carpet is sold to a new customer, the change of ownership is also recorded as a new immutable block.

All the information and features associated with the original map of carpet, the woven pattern, and other important and unique features of a carpet are stored in an immutable electronic format produce a digital certificate. The certificate which is the digital version of handmade carpet reinforced by data-backed evidence about carpet features which are stored on the blockchain.

The certificate quickly emerges on mobile app once the QR code at the back of carpet is scanned and then is verified by an asymmetric encryption method. Even if the QR code is lost from the back of carpet, the embedded message inside carpet pattern will enable us to identify the original carpet. We can also take a few random photos from the back of carpet and use the fingerprint in the system to compare and contrast the so-called pattern with the original map. The original carpet always matches with the fingerprint, else the system crackdowns and reports counterfeit.

### BRIEF DESCRIPTION OF FIGURES

FIG. 1: The unique features of the handmade carpet is stored on the blockchain

FIG. 2: A smart chip periodically pings out to the GPS and store location on the blockchain

FIG. 3: Steganography embed a secret message inside the carpet pattern

FIG. 4: Comparing and contrasting the original map and woven pattern

FIG. 5: Comparing and contrasting the original carpet and replica

FIG. 6: All the features of handmade carpet are transformed into the QR Code, stored on the blockchain

FIG. 7: The QR code is physically attached at the back of carpet

FIG. 8: The QR code and fingerprint connect digital certificate to physical carpet

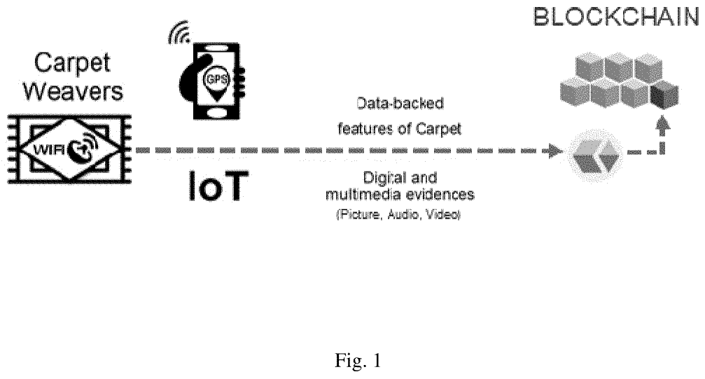

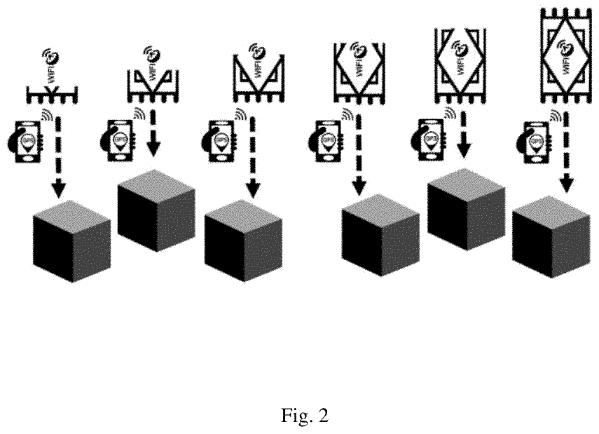

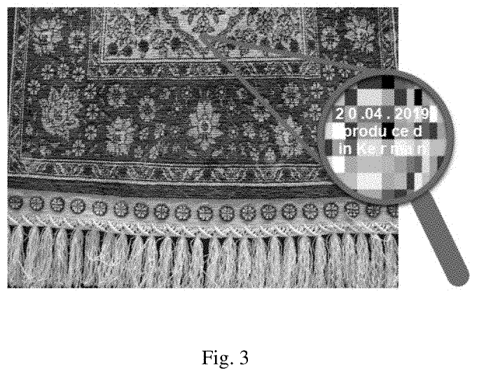

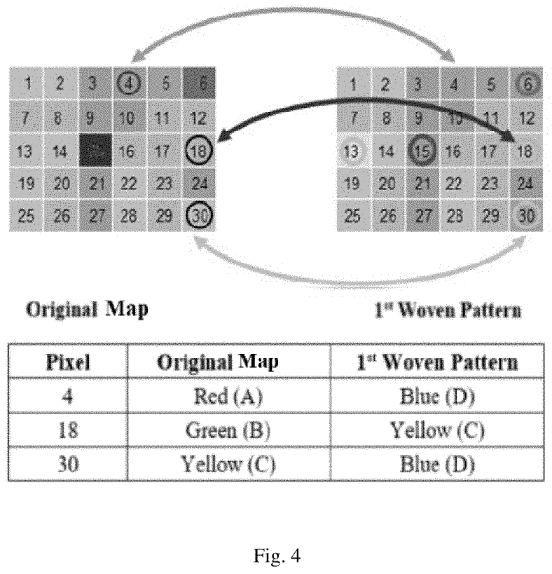

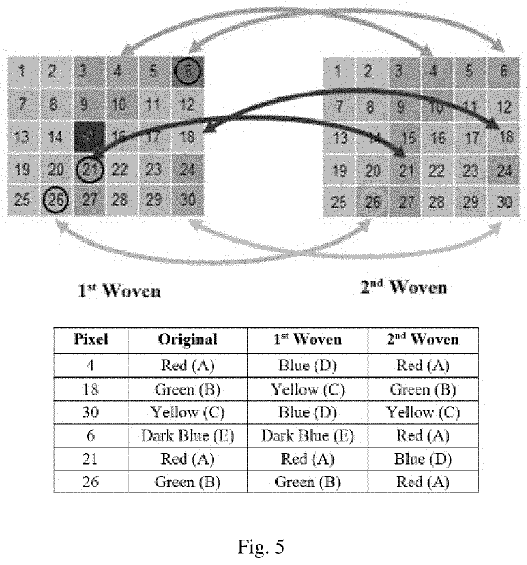

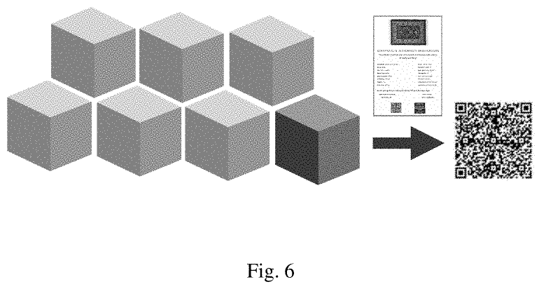

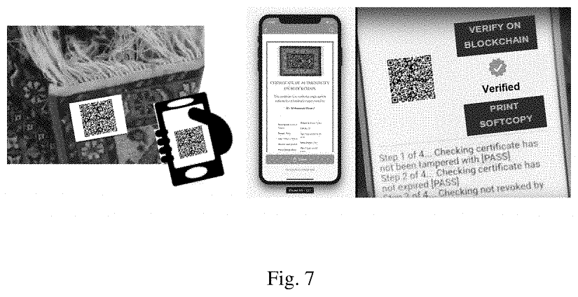

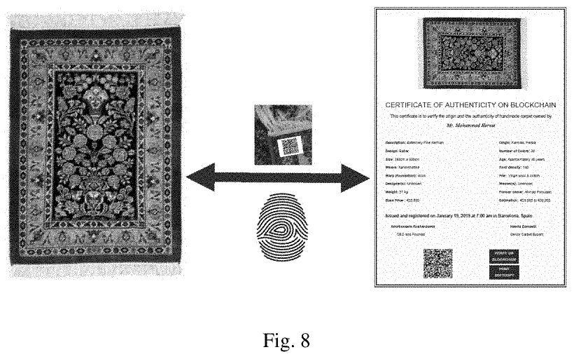

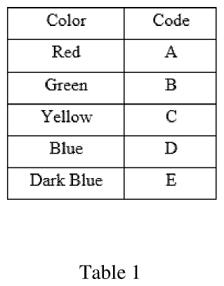

Table 1: The colors coding

1. The invention “Intelligent system for authentication of handmade carpet”, has one Cloud server to record all data collected on the handmade carpet integrated with some other software to process and analyze information. The invention also needs one high-resolution scanner to scan the surface and the back of the handmade carpet. The other requirements are: one image processing program to compare and contrast scanned image of carpet, a smart chip that periodically pings out to the GPS, to fetch the current location of the carpet weaving together with relevant through relevant program, a software to transform all features of the handmade carpet and produce the QR code, a software to store the QR code on the blockchain, a mobile app for installing on smartphone, tablet and notebook to verify the provenance.

2. The invention of claim 1, in which a cloud server is used as a buffer to initially record all data and then data are transformed and stored on the blockchain.

3. The invention of claim 1, where a handmade carpet map is originally provided as a wireframe map in black and white and stored on the blockchain.

4. The invention of claim 1, where information about the design of the map, including time and place, as well as the designer's information is stored on the blockchain.

5. The invention of claim 1, in which a handmade carpet map is stored on the blockchain after being completed and painted in colored pixels.

6. The invention of claim 1, in which information about carpet warp threading, including yarn count, yarn twist, yarn material, and density, as well as warp threading length and width after, are stored on the blockchain.

7. The invention of claim 1, in which information about the marginal weaving, root length, and the number of ridges in base margin woven are stored on the blockchain.

8. The invention of claim 1, in which multimedia information on the weaving process including pictures, audio and video is recorded and stored on the blockchain. Also, a smart chip periodically (monthly intervals) pings out to the GPS to fetch the current location of the carpet weaving and store it on the blockchain.

9. The invention of claim 1, that holds information about the completion date of the weaving process and the location of the finishing process as well as the person responsible for cutting the carpet threading warp or carpet separation from its loom are stored on the blockchain.

10. The invention of claim 1, in which information on the date of completing the process, including probable repairing, the alignment of thread lengths during shrinking operation, or heat treatment, by superficial burning the surface of threads stored on the blockchain.

11. The invention of claim 1, where the surface of the handmade carpet is scanned and then stored on the blockchain.

12. The invention of claim 1, where the back of the handmade carpet is scanned and then is stored on the blockchain.

13. The invention of claim 1, the scanned digital image from the surface and the back of the carpet is analyzed by software and in a dedicated point-to-point pixel to build a meaningful relationship between the dots on the surface and back of the carpet. The information is then stored on the blockchain.

14. The invention of claim 1, where steganography technique embeds a secret message inside the carpet pattern and produces a unique feature like a fingerprint and this also is stored on the blockchain.

15. The invention of claim 1, where human errors during the weaving process form unique features of any carpet the same as a fingerprint and are stored on the blockchain.

16. The invention of claim 1, where the fingerprint evolved from human errors and steganography connects the digital certificate to the physical carpet.

17. The invention of claim 1, where the ownership information of the carpet based on time passage and location of the carpet are stored on the blockchain.

18. The invention of claim 1, in which any changes, including damage to carpet and repairs, as well as changes in ownership, location, physical alteration, including the change in the dimensions or color of the carpet, as a result of time passage, are stored on the blockchain.

19. The invention of claim 1, where all the carpet features are integrated with a digital certificate and transformed to QR Code to be stored on the blockchain.

20. The invention of claim 1, where the QR code is physically attached at the back of the carpet, and the certificate quickly emerges on mobile app once the QR code is scanned and then is verified by an asymmetric encryption method.

21. The invention of claim 1, where the digital certificate of carpet is irrevocable and immutable as it is stored on the blockchain and any changes can be stored as a new block on the blockchain. Therefore the history and background of the carpet are irrevocably maintained.
